(19) United States
(12) Patent Application Publication
(10) Pub. No.: US 2026/0150138 A1
(43) Pub. Date: May 28, 2026

(54) ELECTRONIC DEVICE, RADIO COMMUNICATION METHOD, AND NON-TRANSITORY RECORDING MEDIUM

(71) Applicant: CASIO COMPUTER CO., LTD., Tokyo (JP)

(72) Inventors: Kyohei TAKISHIMA, Tokyo (JP); Naoya OKAMOTO, Tokyo (JP)

(73) Assignee: CASIO COMPUTER CO., LTD., Tokyo (JP)

(21) Appl. No.: 19/376,714

(22) Filed: Oct. 31, 2025

(30) Foreign Application Priority Data
Nov. 26, 2024 (JP) 2024-205838

(51) Int. Cl. H04W 76/14; H04W 4/80; H04W 8/26

(52) U.S. Cl. CPC H04W 76/14; H04W 4/80; H04W 8/26

(57) ABSTRACT

An electronic device includes one or more processors to, in a case where a communication connection by BLE is to be established: execute first operation of repeating transmission of an advertising packet and scanning for an advertising packet at a set cycle; acquire first information by a first method that enables a value different for each device to be acquired; and change the cycle of the first operation, based on the first information during execution of the first operation.

### CROSS-REFERENCE TO RELATED APPLICATIONS

This application claims the benefit of Japanese Patent Application No. 2024-205838, filed on Nov. 26, 2024, the entire disclosure of which is incorporated by reference herein.

### FIELD OF THE INVENTION

This application relates generally to an electronic device, a radio communication method, and a non-transitory recording medium.

### BACKGROUND OF THE INVENTION

In Bluetooth (registered trademark) low energy (BLE), which is one of the short range radio communication standards, generally, a communication connection is established by one of two devices involved in the communication connection transmitting an advertising packet as a peripheral, while the other scanning for the advertising packet as a central and also making a request for a communication connection and the central and the peripheral serving as a master device and a slave device, respectively. In other words, unless which of the two devices serves as a peripheral and which as a central is determined in advance, a normal communication connection cannot be established. With regard to the problem to be solved, for example, Unexamined Japanese Patent Application Publication No. 2016-170630 describes a technology where, even when a peripheral and a central have not been determined in advance, a communication connection is established by one of the devices performing transmission and scanning of an advertising packet simultaneously, and, depending on a response from the other device, determining which is to serve as a master or a slave.

### SUMMARY OF THE INVENTION

In order to achieve the above-described objective, an electronic device of the present disclosure includes one or more processors to, in a case where a communication connection by BLE is to be established: execute first operation of repeating transmission of an advertising packet and scanning for an advertising packet at a set cycle; acquire first information by a first method that enables a value different for each device to be acquired; and change the cycle of the first operation, based on the first information during execution of the first operation.

### BRIEF DESCRIPTION OF DRAWINGS

A more complete understanding of this application can be obtained when the following detailed description is considered in conjunction with the following drawings, in which:

FIG. 1 is a diagram illustrating an image representing a situation where two electronic devices according to an embodiment are performing transmission and reception of an advertising packet to and from each other;

FIG. 2 is a block diagram illustrating a functional configuration of an electronic device according to the embodiment;

FIG. 3 is a diagram for a description of information included in the advertising packet;

FIG. 4 is a diagram for a description of an example in which timings of advertisement and scanning coincide with each other;

FIG. 5 is a diagram for a description of an example in which timings of advertisement and scanning are shifted by interposing an offset;

FIG. 6 illustrates a first part of a flowchart of passing communication processing according to the embodiment;

FIG. 7 illustrates a second part of the flowchart of the passing communication processing according to the embodiment;

FIG. 8 illustrates a third part of the flowchart of the passing communication processing according to the embodiment; and

FIG. 9 illustrates a fourth part of the flowchart of the passing communication processing according to the embodiment.

### DETAILED DESCRIPTION OF THE INVENTION

An embodiment of the present disclosure is described below with reference to the drawings. Note that the same or corresponding parts in the drawings are designated by the same reference numerals.

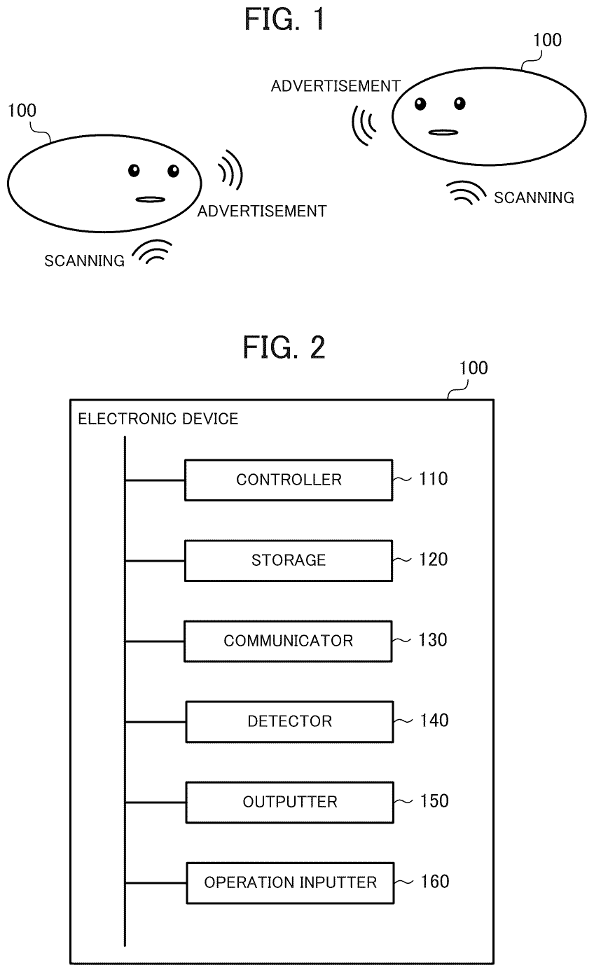

An electronic device 100 according to the embodiment is, as illustrated in FIG. 1, a pet robot having a cute shape. The electronic device 100 periodically performs processing of transmitting an advertising packet and scanning for an advertising packet (receiving an advertising packet) alternately and repeatedly, based on a communication standard Bluetooth (registered trademark) low energy (hereinafter, referred to as BLE), and when two electronic devices 100 come close to each other, a communication connection is established. When a communication connection is established, the pet robots perform actions that make the pet robots appear to be communicating with each other (for example, each of the pet robots utters a cry that is different from the other). For example, two users each of whom carries an electronic device 100 serving as a pet robot come close to each other from separate places and pass each other, a communication connection between the two electronic devices is established and predetermined actions indicating communication between the pet robots (each of the pet robots utters a cry that is different from the other) are performed.

The electronic device 100 includes, as a functional configuration, a processor 110, a storage 120, a communicator 130, a detector 140, an outputter 150, and an operation inputter 160, as illustrated in FIG. 2.

The processor 110 includes, for example, a central processing unit (CPU), and executes passing communication processing, which is described later, and the like by a program stored in the storage 120. Note that the processor 110 is compatible with multithreading functionality in which a plurality of processes is executed in parallel, and can execute various types of processing (such as the passing communication processing, advertisement-scanning repetitive operation, which will be described later, and other processing required for operations of the electronic device 100) in parallel. In addition, the processor 110 has a clock function and a timer function and can count date and time or measure time. Note that the above-described processor may include a single CPU to perform processing alone or include two or more CPUs to perform processing in collaboration with one another.

The storage 120 includes a read only memory (ROM), a flash memory, a random access memory (RAM), and the like. In the ROM, a program that the CPU of the processor 110 executes and data that is required in advance to execute the program are stored. The flash memory is a writable non-volatile memory and stores data that needs to be saved even after power is turned off. In the RAM, data that are generated or modified while the program is executed are stored. The storage 120 also stores, for example, cry data to be output by the outputter 150.

The communicator 130 includes a Bluetooth (registered trademark) controller that performs transmission and reception of a radio signal based on the short range radio communication standard BLE, and establishes a communication connection with another electronic device 100. In addition, the communicator 130 stores a media access control (MAC) address of the electronic device 100 itself that is unique to the electronic device 100, a service UUID (although to be described later, the service UUID can be said to be an ID indicating a service (function) that the electronic device 100 has and be information indicating a type of the electronic device 100) of the electronic device 100 itself, and the like. The MAC address is an identifier used to uniquely identify a device connected to a network, and each device connected to the network is assigned a MAC address that is different from the other.

The detector 140 includes an acceleration sensor and detects acceleration of the electronic device 100. For example, since when a user lifts up or carries the electronic device 100, acceleration other than acceleration (gravitational acceleration) detected while the electronic device 100 is stationary occurs, the processor 110 can determine a movement of the electronic device 100 by comparing the acceleration detected by the detector 140 with the gravitational acceleration.

The outputter 150 includes a motor, a speaker, and the like, and causes the electronic device 100, which serves as a pet robot, to move a body and utter a cry. Note that the outputter 150 does not necessarily have to include a motor and a speaker and can include an arbitrary device to enable the electronic device 100 to perform an action as a pet robot. For example, when the only action that the electronic device 100 performs as a pet robot is to utter a cry, the outputter 150 does not have to include a motor and may include only a speaker.

The operation inputter 160 is an interface to accept a user operation, such as turning the power on and off and adjusting output sound volume.

The functional configuration of the electronic device 100 is described above.

Generally, in BLE, a communication connection is established by one of two devices advertising (transmitting an advertising packet) as a peripheral and the other performing scanning (receiving an advertising packet) as a central. However, since both electronic devices 100 are the same pet robots and communicate with each other under the control of the same software, it is not possible to decide in advance which serves as a peripheral or a central. Therefore, the electronic device 100 performs advertisement and scanning alternately in such a way that the electronic device 100 can operate as both a peripheral and a central.

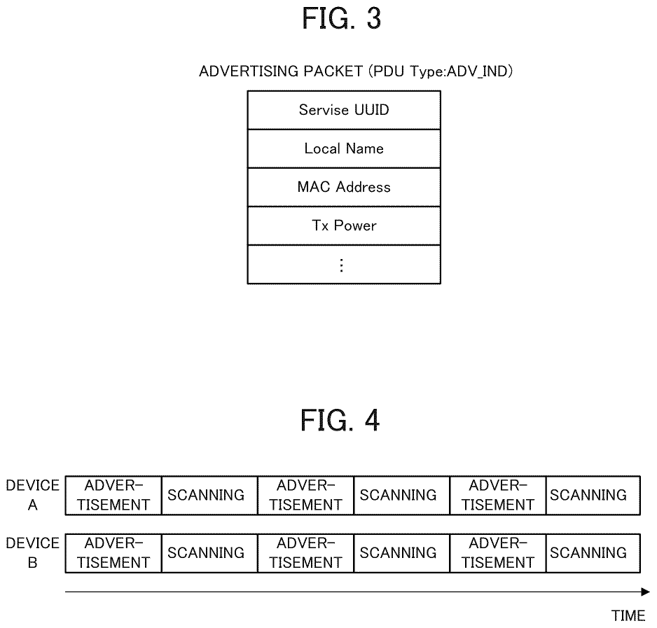

An advertising packet (a packet the protocol data unit (PDU) type of which is ADV_IND) includes, as illustrated in FIG. 3, information about a service universally unique identifier (UUID), local name, a MAC address, transmitter (Tx) power, and the like.

The service UUID is information indicating what type of service (function) the electronic device 100 that transmits the advertising packet has. For example, the service UUIDs of two electronic devices 100 coinciding with each other means that the two electronic devices 100 are of the same type (for example, having the same model number).

Although the local name is information indicating a name of the electronic device 100 that transmits the advertising packet, the local name is not used in the present embodiment.

The MAC address is information indicating a MAC address of the electronic device 100 that transmits the advertising packet.

The Tx power is information indicating transmission power of the advertising packet. In practice, the Tx power indicates a value of received signal strength indicator (RSSI) that is received signal strength when the advertising packet is received at a point located a reference distance (for example, 1 m) away from a transmission point.

In addition, the communicator 130 measures, when receiving a radio wave, received signal strength of the radio wave, and the processor 110 acquires the received signal strength as a value of the RSSI. When receiving an advertising packet, the processor 110 also acquires RSSI as information indicating the received signal strength of the advertising packet. In an ideal environment, when the value of the RSSI is greater than or equal to the value of the Tx power, it can be assumed that distance to the electronic device 100 that transmits the advertising packet is less than or equal to the reference distance. Note, however, that since in practice, various factors cause the value of the RSSI to change, the distance calculated based on the RSSI and the Tx power serves as an approximate distance.

In the present embodiment, since two electronic devices 100 that are to establish a communication connection in BLE are the same pet robots and are equal to each other, it is not possible, as described above, to determine in advance which serves as a central and which serves as a peripheral. In the present embodiment, when such two electronic devices 100 are to establish a communication connection in BLE, each of the two electronic devices 100 transmits an advertising packet as a peripheral and each of the two electronic devices 100 also performs scanning (receives an advertising packet) as a central. By the configuration as described above, when a timing when transmission of an advertising packet by one of the two electronic devices 100 and scanning for an advertising packet by the other are performed simultaneously occurs, a communication connection can be established.

However, for example, in a case where, as illustrated in FIG. 4, timing of transmission and scanning of an advertising packet performed by one of the electronic devices 100 (device A) coincides with timing of transmission and scanning of an advertising packet performed by the other of the electronic devices 100 (device B), each of the two electronic devices 100 cannot receive an advertising packet transmitted by the other. Therefore, when a situation as illustrated in FIG. 4 occurs, it is required to somehow shift timings at which the two electronic devices 100 transmit advertising packets from each other.

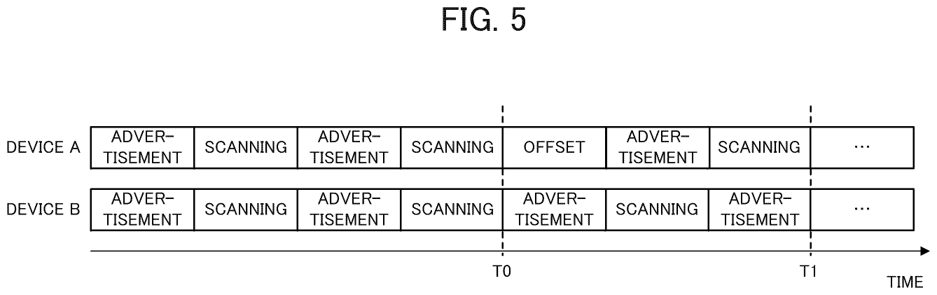

In the present embodiment, as illustrated in FIG. 5, even in a situation in which the two electronic devices 100 (the device A and the device B) repeatedly transmit an advertising packet and perform scanning at the same timing, the above-described problem is solved by interposing, at a predetermined timing, an offset (waiting time) to delay the timing of transmission and scanning of an advertising packet and thereby shifting the timings of subsequent transmission and scanning of an advertising packet. For example, in the example illustrated in FIG. 5, the device A interposing an offset at a time point TO enables each of the devices A and B to receive an advertising packet from the other by scanning at a time point T1. Note, however, that since both the device A and the device B are basically electronic devices 100 having the same hardware and software, when the devices A and B simply interpose an offset, there is a possibility that offsets of the same length are interposed at the same timing, and in this case, the timing of the advertising packet transmission and the timing of scanning eventually cannot be shifted. To solve this problem, it is only required to acquire device unique information (first information) unique to each electronic device 100 using a method in which a different value can be acquired with respect to each electronic device 100 (first method) and set time length of the offset (hereinafter, referred to as “offset value”) or timing when the offset is interposed, based on the device unique information, which differs with respect to each electronic device 100. In the present embodiment, the offset value is set using a value of acceleration detected by the acceleration sensor or a value of the MAC address as the device unique information (It is also configured to set the timing when an offset is interposed based on timing when a predetermined acceleration is detected). Note, however, that in consideration of a case where using a MAC address value as it is may pose a problem from a security standpoint, the present embodiment calculates a hash value from the MAC address and determines the offset value based on the calculated hash value.

Note that since in a case where even when an offset is interposed, the offset value is too small, the amount of shift between the timing of transmission of an advertising packet and the timing of scanning for the advertising packet becomes small and length of time during which an advertising packet transmitted from one of the electronic devices 100 can be received by the scanning by the other becomes significantly short, it becomes extremely difficult to establish a communication connection. Conversely, since when the offset value is too long, the waiting time (time during which neither transmission of an advertising packet nor scanning for an advertising packet is performed) becomes long, it also becomes extremely difficult to establish a communication connection.

Therefore, it is desirable to set an appropriate minimum value and maximum value for a range within which the offset value is varied. In the present embodiment, the offset value is calculated in such a way that the minimum value and maximum value of the offset value are 1 second and 3 seconds, respectively.

For example, an example of a method for determining the offset value in a case of using a hash value calculated from a MAC address is described below.

Although an arbitrary function can be used as a hash function when a hash value is calculated, in the present embodiment, widely accepted SHA-256 (secure hash algorithm 256-bit) is used. SHA-256 generates a 256-bit (32-byte) hash value from data of arbitrary length up to 2 to the power of 64 minus 1 bits.

In the present embodiment, although the MAC address is input into SHA-256 to calculate a hash value, the calculated hash value is treated as a byte string of 32 bytes (Hash[0] to Hash[31]), a byte is extracted from the byte string, and the offset value is calculated from a value of the extracted byte (Hash[i], where i=0 to 31) using the following formula (1).

$$Offset value ( seconds ) = 1 + Hash [ i ] \times 0.00 \; 784 \qquad ( 1 )$$

Since each byte (Hash[i]) in the byte string takes a value from 0 to 255, when the offset value is calculated using the formula (1), the offset value is 1 second or more and 2.9992 seconds or less. Note that the coefficient 0.00784 by which the byte value (Hash[i]) is multiplied in the formula (1) is only an example of the coefficient, and an arbitrary value can be set to the coefficient as long as the value ensures that practically different offset values are generated from different byte values (within a range of the minimum value or more and the maximum value or less). In addition, as for the mathematical formula, without being limited to the formula (1), an arbitrary mathematical formula can be set as long as the mathematical formula causes the offset value to be set in such a way that the offset value varies within the range of the minimum value or more and the maximum value or less.

In addition, an example of a method for determining the offset value based on acceleration is described below.

Since acceleration is generally a three-dimensional vector, for example, an absolute value (A) of the acceleration is calculated to convert the acceleration vector to a scalar value, and the largest even number (B) among even numbers smaller than the absolute value (A) is subtracted from the absolute value (A) and 1 is added to the result of the subtraction. That is, the offset value is calculated by the formula (2) below.

$$Offset value ( seconds ) = ( A - B ) + 1 \qquad ( 2 )$$

Since A-B is a value of 0 or more and less than 2, when the offset value is calculated by the formula (2), the offset value is a value of 1 or more and less than 3. Note that the formula (2) is only an example of a mathematical formula for calculating the offset value from acceleration, and an arbitrary mathematical formula can be set as long as the mathematical formula causes practically different offset values to be generated (within the range of the minimum value or more and the maximum value or less) from different acceleration values.

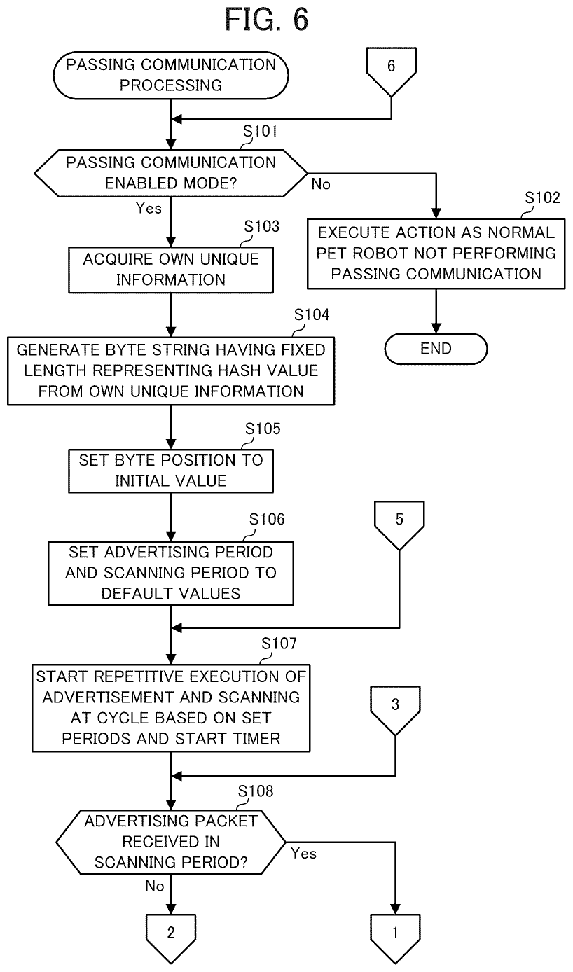

Based on the above-described concept, processing (passing communication processing) to establish a communication connection when two electronic devices 100 pass each other (for example, when two persons each of whom carries an electronic device 100 as a pet robot and who walk toward each other on the same road from opposite directions pass each other) is described with reference to FIGS. 6 to 9. Execution of this processing is started when an operation mode of the electronic device 100 is set to a “passing communication enabled mode”. Although how the operation mode of the electronic device 100 is set can be arbitrarily determined, the operation mode may be set by the user operating a switch to switch the operation mode included in the operation inputter 160, or the operation mode may be configured to be settable by the user operating an external device (for example, a smartphone) via the communicator 130.

First, the processor 110 determines whether or not the current operation mode of the electronic device 100 is the passing communication enabled mode (step S101).

When the current operation mode of the electronic device 100 is not the passing communication enabled mode (step S101; No), the processor 110 is set to execute an action as a normal pet robot that does not perform passing communication (step S102), and terminates the passing communication processing.

When the current operation mode of the electronic device 100 is the passing communication enabled mode (step S101; Yes), the processor 110 acquires a MAC address that is unique information of the electronic device 100 itself from the communicator 130 (step S103). Next, the processor 110 generates a byte string (in the present embodiment, a numerical string Hash[0] to Hash[31]) of a fixed length (in the present embodiment, 32 bytes) that represents a hash value from the unique information to the electronic device 100 itself (MAC address) (step S104). Next, the processor 110 sets a byte position variable i that specifies a position of a byte in the byte string to an initial value (for example, 0) (step S105). Next, the processor 110 sets an advertising period (length of time during which an advertising packet is transmitted) and a scanning period (length of time during which scanning is performed) in BLE to default values (for example, the advertising period and the scanning period are set to 5 seconds and 2 seconds, respectively) (step S106). Next, the processor 110 starts repetitive execution of transmission and scanning of an advertising packet at a cycle based on the set periods (the advertising period and the scanning period) and starts a timer (step S107). Note that the operation of repeating transmission of an advertising packet and scanning for an advertising packet at a set cycle (advertisement-scanning repetitive operation), which is started in step S107, is executed in parallel with the execution of the passing communication processing. In addition, the advertisement-scanning repetitive operation is also referred to as a first operation.

Next, the processor 110 determines whether or not having received an advertising packet from another electronic device 100 in the scanning period (step S108).

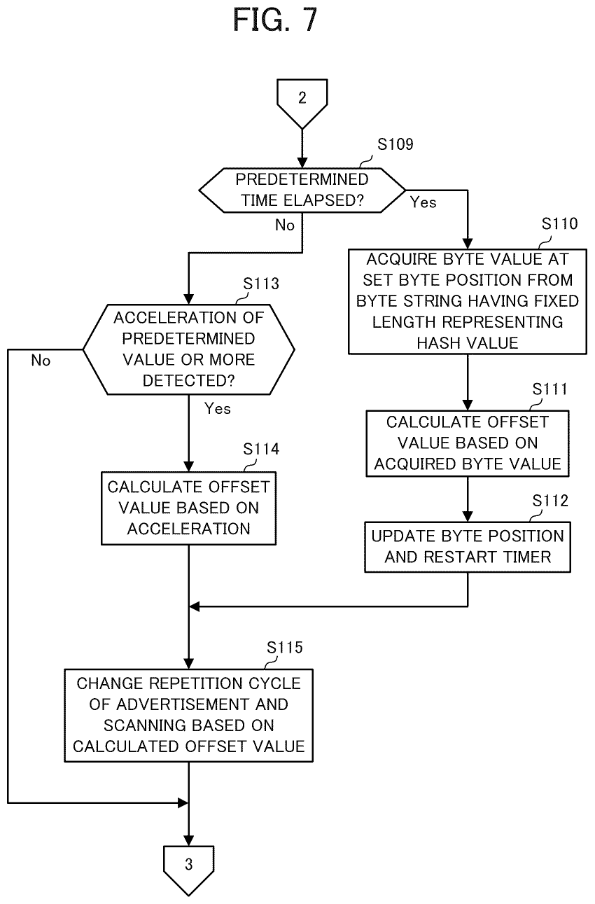

When not having received an advertising packet (step S108: No), the processor 110 proceeds to FIG. 7, and determines whether or not a predetermined time (for example, 15 seconds) has elapsed with the timer that is started in step S107 (or restarted in step S112, which is described later) (step S109). When the predetermined time has elapsed (step S109: Yes), the processor 110 acquires a byte value (Hash[i]) at a position indicated by the byte position variable i from the byte string (Hash[0] to Hash[31]) of a fixed length that represents a hash value (step S110). Next, the processor 110 calculates an offset value, based on the acquired byte value (for example, by the formula (1)) (step S111). Next, the processor 110 updates the byte position variable i (when i is 30 or less, adding 1 to the byte position variable i, and when i is 31, returning the byte position variable i to 0) and restarts the timer from 0 (step S112), and proceeds to step S115.

When the predetermined time has not elapsed (step S109; No), the processor 110 determines whether or not the detector 140 has detected an acceleration of a predetermined acceleration or more (step S113). The acceleration of a predetermined acceleration or more refers to an acceleration that is acceleration other than gravitational acceleration and that is detected when the user moves the electronic device 100 or the user carrying the electronic device 100 moves.

When no acceleration of a predetermined acceleration or more has been detected (step S113; No), the processor 110 returns to step S108 in FIG. 6.

When an acceleration of a predetermined acceleration or more is detected (step S113; Yes), the processor 110 calculates an offset value, based on a value of the detected acceleration (for example, by the formula (2)) (step S114), and proceeds to step S115.

In step S115, the processor 110 changes a repetition cycle of the advertisement-scanning repetitive operation, based on the offset value calculated in step S111 or S114 (step S115). For example, the processor 110 changes the repetition cycle by interposing an offset period with a length represented by the offset value between a scanning period and an advertising period. Subsequently, the processor 110 returns to step S108 in FIG. 6.

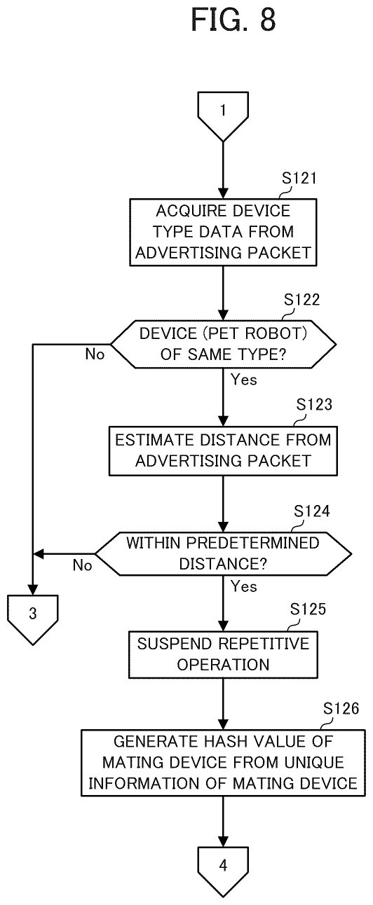

On the other hand, when in step S108 in FIG. 6, an advertising packet is received from another electronic device 100 in the scanning period (step S108; Yes), the processor 110 proceeds to FIG. 8 and acquires device type data (service UUID) from the received advertising packet (step S121). Next, the processor 110 compares the acquired device type data with the device type data of the electronic device 100 itself and determines whether or not the another electronic device is a device of the same type (pet robot) (step S122).

When the another electronic device 100 is not a device of the same type (step S122; No), the processor 110 returns to step S108 in FIG. 6.

When the another electronic device 100 is a device of the same type (step S122; Yes), the processor 110 estimates distance from the received advertising packet and the RSSI of the advertising packet (step S123). The estimation of distance can be, as described above, performed based on the Tx power included in the advertising packet and the RSSI that is the received signal strength of the advertising packet. Next, the processor 110 determines whether or not the estimated distance is within a predetermined distance (for example, 1 m) (step S124).

When the estimated distance is not within the predetermined distance (step S124; No), the processor 110 returns to step S108 in FIG. 6.

When the estimated distance is within the predetermined distance (step S124; Yes), the processor 110 suspends the advertisement-scanning repetitive operation (step S125). Next, the processor 110 generates, from unique information (the MAC address included in the received advertising packet) of a mating device, a hash value of the mating device (step S126).

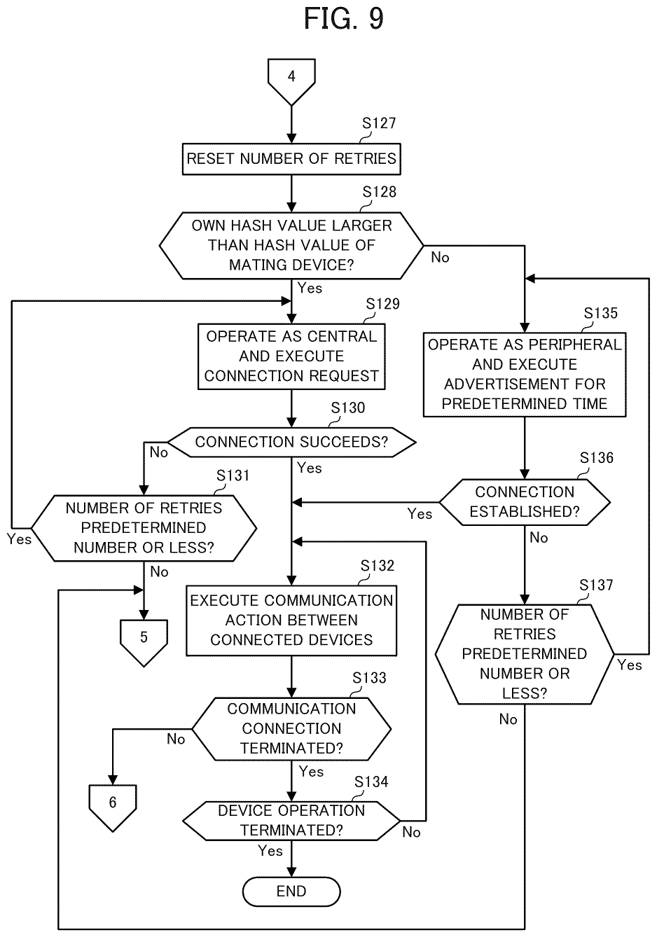

Next, the processor 110 proceeds to FIG. 9 and resets the number of retries that is counted in steps S131 and S137, which are described later (step S127). Next, the processor 110 determines whether or not the hash value of the electronic device 100 itself is larger than the hash value of the mating device (step S128).

When the hash value of the electronic device 100 itself is larger than the hash value of the mating device (step S128; Yes), the processor 110 causes the electronic device 100 to operate as a central in a fixed manner (causes, after establishment of a communication connection, the electronic device 100 to function as a master device that controls transmission and reception of data), and transmits a connection request to the mating device (step S129). Next, the processor 110 determines whether or not the connection has succeeded (step S130).

When the connection has not succeeded (step S130; No), the processor 110 updates the number of retries (adds 1 to the number of retries), and determines whether or not the number of retries is less than or equal to a predetermined number of times (for example, five times) (step S131). When the number of retries is less than or equal to the predetermined number of times (step S131; Yes), the processor 110 returns to step S129. When the number of retries exceeds the predetermined number of times (step S131; No), the processor 110 returns to step S107 in FIG. 6.

When the connection succeeds (step S130; Yes), the processor 110 executes communication action between the electronic devices 100 connected to each other (step S132). Although the communication action may be an arbitrary action, as an example, a cry as a central and a cry as a peripheral are stored in the storage 120 in advance, and the processor 110 causes, when connecting to the mating device as a central, the outputter 150 to output the cry as a central and, when connecting to the mating device as a peripheral, the outputter 150 to output the cry as a peripheral. Next, the processor 110 determines whether or not the communication connection is terminated (step S133). For example, when the two electronic device 100 that have communication connection established separate away from each other and a radio wave does not reach the mating device, the communication connection is to be terminated. When the communication connection has not been terminated (step S133; No), the processor 110 returns to step S101 in FIG. 6. When the communication connection is terminated (step S133; Yes), the processor 110 determines whether or not the operation of the electronic device 100 is terminated (step S134). For example, when the user operates the operation inputter 160 and outputs an instruction to terminate the operation of the electronic device 100 (for example, turns off the power switch), the processor 110 is to terminate the operation of the electronic device 100. When the operation of the electronic device 100 is not to be terminated (step S134; No), the processor 110 returns to step S132 and repeats the communication action between the electronic devices 100. When the operation of the electronic device 100 is to be terminated (step S134; Yes), the processor 110 terminates the passing communication processing.

On the other hand, when in the determination in step S128, the hash value of the electronic device 100 itself is less than or equal to the hash value of the mating device (step S128; No), the processor 110 causes the electronic device 100 to operate as a peripheral in a fixed manner (causes, after the establishment of a communication connection, the electronic device 100 to function as a slave device that performs transmission and reception of data in accordance with control by the master device), and executes advertisement (transmission of an advertising packet) for a predetermined time (for example, 15 seconds) (step S135). Next, the processor 110 determines whether or not the connection with the mating device has been established (step S136). When the connection is established (step S136; Yes), the processor 110 proceeds to step S132. When the connection has not been established (step S136; No), the processor 110 updates the number of retries (adds 1 to the number of retries), and determines whether or not the number of retries is less than or equal to the predetermined number of times (for example, five times) (step S137). When the number of retries is less than or equal to the predetermined number of times (step S137; Yes), the processor 110 returns to step S135. When the number of retries exceeds the predetermined number of times (step S137; No), the processor 110 returns to step S107 in FIG. 6.

Since by the passing communication processing described above, the processor 110 acquires a value (first information such as a hash value and acceleration) that is different with respect to each electronic device 100, using a MAC address or the acceleration sensor and changes the cycle of the advertisement-scanning repetitive operation, based on the first information while executing the advertisement-scanning repetitive operation, it is possible to establish a communication connection in a stable manner even when, between electronic devices 100 each of which does not have a function to perform transmission and scanning of an advertising packet at the same time, which electronic device 100 serves as a peripheral or a central is not determined in advance.

A conventional technology described in Unexamined Japanese Patent Application Publication No. 2016-170630 is constructed on the assumption that one of the devices has a function of performing transmission and scanning of an advertising packet at the same time, and there have been cases where it is difficult to establish a communication connection in a stable manner between devices that do not have such a function. The present disclosure is to solve the problem as described above in the conventional technology, and according to the present disclosure, it is possible to establish a communication connection in a stable manner even when, between devices each of which does not have a function of performing transmission and scanning of an advertising packet at the same time, the peripheral and the central have not been determined in advance.

In addition, by use of a method using a MAC address as a method (first method) for acquiring a different value with respect to each electronic device 100, a value guaranteed to be certainly different from a value from a different electronic device 100 can be acquired as device unique information (first information).

In addition, using a hash value generated based on a MAC address as device unique information (first information) enables a problem in security that is likely to occur due to directly using a MAC address to be avoided.

In addition, since the processor 110, in steps S110 to S112 and S115 in the passing communication processing (FIG. 7), cuts out a portion of a numerical string (byte string) representing a hash value (extracts a byte value at a position indicated by the byte position variable i), generates offset time (offset value) using the cut-out numerical string, changes the cycle of the advertisement-scanning repetitive operation using the generated offset time, and changes, during a period until a communication connection is established, the position at which a portion of the numerical string is cut out (byte position variable i), the processor 110 is capable of generating a variety of offset values.

In addition, since the processor 110 determines, in step S128 in the passing communication processing (FIG. 9), whether the electronic device 100 serves as a central or a peripheral, based on the first information (in the present embodiment, a hash value) at the time of establishing a communication connection, a communication connection can be established in a stable manner even when which electronic device 100 serves as a peripheral or a central is not determined in advance.

In addition, since the processor 110 changes, in steps S113 to S115 in the passing communication processing (FIG. 7), the cycle of the advertisement-scanning repetitive operation at a timing when a predetermined acceleration is detected by the acceleration sensor during execution of the advertisement-scanning repetitive operation, a communication connection can be quickly established in accordance with motion of the user even before the predetermined time has elapsed in step S109.

In addition, since the processor 110, in steps S122 and S124 in the passing communication processing (FIG. 8), determines whether or not the mating device is a device of the same type and whether or not estimated distance to the mating device is less than or equal to a predetermined distance, based on an advertising packet and, when determining that the mating device is a device of the same type and the estimated distance is less than or equal to the predetermined distance, causes a communication connection with the mating device to be established, it is possible to establish a communication connection only when the same pet robots come close to each other within the predetermined distance, and the function of so-called “passing communication” can be achieved.

In addition, since the processor 110, in step S132 in the passing communication processing (FIG. 9), executes, after causing a communication connection to be established, a predetermined action indicating communication between the pet robots, the user feels more affection for the electronic device 100 serving as a pet robot and users who carry pet robots can recognize that the users pass each other, which enables exchange between the users of the electronic devices 100 serving as pet robots to be facilitated.

Note that the present disclosure is not limited to the above-described embodiment and various modifications are applicable.

For example, although in the above-described embodiment, a MAC address or a detected value by the acceleration sensor is used as the first information, which is different with respect to each electronic device 100, the first information is not limited thereto. Arbitrary information may be used as the first information as long as the information enables a different value to be acquired with respect to each electronic device 100. For example, the electronic device 100 may include a sensor other than the acceleration sensor, such as a gyro sensor, and acquire a detected value by the sensor as the first information or may include a sensor to acquire biometric information (such as a pulse and blood pressure) and acquire biometric information of the user as the first information. In addition, the electronic device 100 may acquire, as acquired information having a possibility that error occurs with respect to each electronic device 100, information about temperature, time, or the like as the first information. In addition, random numbers generated in each electronic device 100 may be used as the first information. Note, however, that since among the various types of information described above, the MAC address is particularly guaranteed to be a value that is certainly different with respect to each electronic device 100, there is an advantage in that when the MAC address is used as the first information to calculate an offset value, calculating an offset value only once enables the offset value to be certainly different with respect to each electronic device 100.

In addition, although in the above-described embodiment, after establishment of a communication connection, an electronic device 100 that has a larger hash value calculated from a MAC address is set as a central (master device) in a fixed manner, a reverse configuration (an electronic device 100 that has a larger hash value is set as a peripheral (slave device) in a fixed manner) may be employed.

In addition, although in the above-described embodiment, as a value (first information) to be used for determination of an offset value and determination of whether to function as a central or a peripheral, a hash value generated from a MAC address is used without directly using the MAC address in consideration of security, the MAC address may be directly used without calculating a hash value when the security does not have to be emphasized, or the like.

In addition, although in the above-described embodiment, as a method for changing the cycle of the advertisement-scanning repetitive operation, a method of interposing an offset is described, the method for changing the cycle is not limited to the interposition of an offset. The cycle may be changed by, in place of interposing an offset or in conjunction with interposing an offset, changing (extending or reducing) length of the advertising period or the scanning period. In addition, in place of calculating an offset value based on a MAC address or a hash value, it may be configured such that a change ratio of the cycle is calculated based on a MAC address or a hash value and length of one cycle including an advertising period and a scanning period is increased or decreased using the calculated ratio.

In addition, in the above-described embodiment, the description is made under the assumption that the electronic device 100 is a pet robot. However, the electronic device 100 does not have to be a pet robot. For example, the electronic device 100 may be a wristwatch, and a predetermined action indicating communication between electronic devices 100 may be reproduction of a predetermined melody (a melody indicating a central and a melody indicating a peripheral). In this case, when users who wear the wristwatches come close to each other, different melodies are reproduced from the wristwatches of the users by the passing communication processing.

In addition, although in the above-described embodiment, a communication connection is configured to be established when the service UUIDs coincide with each other, the coincidence between the service UUIDs is not essential. For example, the electronic devices 100 may be configured to establish a communication connection therebetween when the electronic devices 100 are, even when being of different types the service UUIDs of which do not coincide with each other, electronic devices produced by the same maker.

In the above-described embodiment, the description is made under the assumption that an operation program that the CPU of the processor 110 executes is stored in the ROM or the like of the storage 120 in advance. However, the present disclosure is not limited to the configuration, and by implementing an operation program to execute the above-described various types of processing into an existing general-purpose computer or the like, the computer may be made to function as a device to control the electronic device 100 according to the above-described embodiment.

An arbitrary method can be employed as a providing method of such a program, and, for example, the program may be stored in and distributed by a non-transitory computer-readable recording medium (such as a flexible disk, a compact disc (CD)-ROM, a digital versatile disc (DVD)-ROM, a magneto-optical disc (MO), a memory card, and a USB memory) or may be provided by storing the program in a storage on a network, such as the Internet, and causing a user to download the program.

In addition, when the above-described processing are to be executed through sharing of processing between an operating system (OS) and an application program or collaboration between the OS and the application program, only the application program may be stored in a non-transitory recording medium or a storage. In addition, it is also possible to superimpose a program on a carrier wave and distribute the program via a network. For example, the above-described program may be posted on a bulletin board system (BBS) on the network, and the program may be distributed via the network. The above-described processing may be configured to be able to be performed by starting up and executing the distributed program in a similar manner to other application programs under the control of the OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An electronic device, comprising
one or more processors configured to,
in a case where a communication connection by BLE is to be established:
execute first operation of repeating transmission of an advertising packet and scanning for an advertising packet at a set cycle;
acquire first information by a first method that enables a value different for each device to be acquired; and
change the cycle of the first operation, based on the first information during execution of the first operation.

2. The electronic device according to claim 1, wherein the first method is a method in which a MAC address that is unique to each device is used.

3. The electronic device according to claim 2, wherein the first information is a hash value that is generated based on the MAC address.

4. The electronic device according to claim 3, wherein
the one or more processors:
generate an offset time by cutting out a portion of a numerical string that represents the hash value;
change the cycle of the first operation, using the generated offset time; and
change a position at which a portion of the numerical string is cut out during a period until a communication connection is established.

5. The electronic device according to claim 1, wherein
the one or more processors:
generate an offset time, based on the first information; and
change the cycle of the first operation by interposing the generated offset time between an advertising period during which transmission of the advertising packet is performed and a scanning period during which scanning for the advertising packet is performed or extending the advertising period or the scanning period by the generated offset time.

6. The electronic device according to claim 1, wherein
the one or more processors
determine, after establishment of a communication connection, whether causing the electronic device to function as a central, the central controlling transmission and reception of data, in a fixed manner or to function as a peripheral, the peripheral performing transmission and reception of data in accordance with control of a central, in a fixed manner, based on the first information.

7. The electronic device according to claim 1, further comprising
an acceleration sensor,
wherein the one or more processors
change the cycle of the first operation at a timing when a predetermined acceleration is detected by the acceleration sensor during execution of the first operation.

8. The electronic device according to claim 1, wherein
the one or more processors:
determine, based on an advertising packet received by the scanning, whether or not a device that transmits the advertising packet is a device of a same type as the electronic device itself and whether or not estimated distance between the electronic device itself and the device is less than or equal to a predetermined distance; and
cause, in a case where it is determined that the device is a device of the same type as the electronic device itself and the estimated distance between the electronic device itself and the device is less than or equal to a predetermined distance, a communication connection with the device to be established.

9. The electronic device according to claim 7, wherein
a type of the device is a pet robot, and
the one or more processors
execute, after causing a communication connection with the device to be established, a predetermined action indicating communication between pet robots.

10. A radio communication method for establishing a communication connection by BLE, the radio communication method comprising:
by one or more processors,
executing first operation of repeating transmission of an advertising packet and scanning for an advertising packet at a set cycle;
acquiring first information by a first method that enables a value different for each device to be acquired; and
changing the cycle of the first operation, based on the first information during execution of the first operation.

11. A non-transitory computer-readable recording medium storing a program for establishing a communication connection by BLE and causing one or more processors to execute processing comprising:
executing first operation of repeating transmission of an advertising packet and scanning for an advertising packet at a set cycle;
acquiring first information by a first method that enables a value different for each device to be acquired; and
changing the cycle of the first operation, based on the first information during execution of the first operation.
